(19) United States
(12) Patent Application Publication
(10) Pub. No.: US 2007/0213190 A1
(43) Pub. Date: Sep. 13, 2007

(54) Folding device for folding textile or other foldable material

(76) Inventor: Johannes Jacobus Maria Oerlemans, Zaltbommel (NL)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/717,586

(22) Filed: Mar. 13, 2007

(30) Foreign Application Priority Data
Mar. 13, 2006 (NL) 2000024

(51) Int. Cl. B31B 1/26

(52) U.S. Cl. 493/231

(57) ABSTRACT

The invention relates to a device for folding articles of foldable material, such as towels or pillowcases. The articles includes at least two article parts which are to be folded over each other, a first horizontally supported part and at least a second, depending part. The device comprises a frame, a transport element in the frame the width of which is at least as great as that of a first article part, and at least a first folding element extending from a first side of the transport element to below or above the transport element for the purpose of forcing the second, depending article part to a position respectively below or above the transport element. The device further includes a first engaging element disposed on the first side of the transport element partially below or above the transport element and which engages the second article part situated respectively below or above the transport element and which exerts a pulling force on the second article part in the direction of movement of the transport element.

### CROSS REFERENCE TO RELATED APPLICATIONS

This application claims priority of Netherlands Pat. Appl. NL 2000024, filed Mar. 13, 2006, the entirety of which is incorporated herein by reference.

### STATEMENT REGARDING FEDERALLY SPONSORED RESEARCH OR DEVELOPMENT

### N/A

### BACKGROUND OF THE INVENTION

The presently disclosed invention relates to a device for folding flat articles made of foldable material, such as towels, pillowcases or items of clothing such as hospital gowns. The articles for folding comprise a first article part and a second article part and the device comprises a frame, a transport element which is placed in the frame and the width of which is at least as great as that of the first article part, and a first folding element extending from the first side of the transport element to below or above the transport element for the purpose of forcing the second article part to a position respectively below or above the transport element.

Such a device is known from U.S. Pat. No. 3,829,081. This prior art folding device is only provided with a folding element for guiding and folding that part of the article that must be folded. Because the entire article to be folded is not disposed within the device during folding and as a consequence of frictional forces, the article part for folding tends to be pulled askew, whereby the resulting fold is generally misaligned.

It is known from European Pat. Appl. 0881322 to fold an article by means of blowing with air. However, using air for initiating a fold can only be performed once the whole article has been placed in the relevant folding device. Longer devices are thus required to employ air folding techniques.

### BRIEF SUMMARY OF THE INVENTION

The presently disclosed invention comprises a device having a first engaging element which is on a first side of a transport element. In one embodiment, the transport element is a continuous belt in contact with a first article part for urging the article through the device. The first engaging element is disposed partially below or above the transport element, and is adapted to engage a second article part situated on the same side of the transport element. The first engaging element is provided to exert a pulling force on the second article part in the direction of movement of an article transport element that engages the first article part.

The article part to be displaced for the purpose of folding is driven by both the transport element and by the engaging element. The engaging element generates a force substantially parallel to the direction of movement of the transport element, thus avoiding the danger of the second article part being pulled askew relative to the direction of travel of the first article part and, as a result, having a misaligned fold.

The presently disclosed invention likewise relates to a method for folding articles made of foldable material, such as towels, wherein the method comprises the steps of using positioning means to place the article partially into engagement with a transport element, such as a continuous belt, and transporting the article with the transport element. Parts of the article not in engagement with the transport element are forced by a first guide extending from a side of the device below or above the transport element to a respective position below or above the transport element. After covering a certain distance, parts of the article not in engagement with the transport element, having been forced laterally across the path of travel by the first guide, are engaged by an engaging element, wherein the engaging element exerts a pulling force on the relevant article part in the direction of movement of the transport element.

According to a preferred embodiment, the first engaging element is a movable engaging element which can be driven with a velocity component, in the direction of movement of the transport element, at least as great as the speed of the transport element itself. As a result of use of the first engaging element, there is a reduced likelihood of the article being pulled askew and of the fold being misaligned.

The implementation of the engaging element is simplified when the first movable engaging element comprises a first rotatable disc, preferably provided on its periphery with bristles extending radially outward about the outer circumference of the disc.

The effectiveness of the disc and the simplicity of the construction are further simplified when the first rotatable disc is disposed in a substantially horizontal plane above or below the plane of the transport element and when the tangent of the first rotatable disc in the direction of article movement corresponds with the vertical projection of the transport element edge opposite from the first guide.

A fold can be obtained by folding the second article part to a position above the first article part, as is otherwise known per se from U.S. Pat. No. 3,980,290, although it is mechanically attractive for the first guide to be adapted to fold the second article part to a position below the transport element. Use can thereby be made of the force of gravity.

The above described embodiments are adapted to make a single fold, so that a folded article results with two layers and a single fold. It may be desirable, particularly in the case of large articles, to form more layers. For this purpose, in a further embodiment, the device is adapted to fold a first, a second and a third article part over each other, wherein the width of the transport element corresponds to that of the first article part. In this embodiment, the device comprises a second guide for forcing the third article part to a position below or above the transport element and wherein the device comprises a second engaging element which is placed on the first side of the transport element partially below or above the transport element and which is adapted to engage the third article part and to exert a pulling force on the third article part in the direction of movement of the transport element. With this device it is possible to fold an article, such as a flat sheet, into a three-layer structure.

So that the discs can be in contact with the article part over a long path and exert a sufficiently great force while running through this path, it is necessary for the discs to have a large diameter. When the diameter of each of the discs is greater than the width of the transport element, it is preferred that the second rotatable disc be placed behind the first rotatable disc in the direction of movement of the transport element.

As elucidated above, it is preferred that the second and optionally the third article part are folded from below against the first article part already extending horizontally. It is then preferred to make the distance between the initial horizontal first article part and the upward folded article parts as short as possible. This is preferably achieved via the transport element comprising a folding template and a conveyor belt extending thereabove, and wherein the conveyor belt is adapted to move articles for folding over the folding template. This prevents a conveyor belt being situated between the parts folded toward each other, which could result in fold irregularities at the end of the conveyor belt.

Another preferred embodiment provides that the folding template comprise two slide strips, wherein the distance between the strips can be changed. It is possible to change the width of the first article part, which is determined by the width of the folding template. It is preferred to fix the lateral position of one slide strip comprising the folding template and to make the lateral position of the other slide strip comprising the folding template movable.

This is embodied structurally in a spindle which extends transverse to the direction of movement of the transport element and which is adapted to displace the second slide strip on the first side of the folding template. The second slide strip, second folding guide, and second engaging element are hereby connected to each other so that they can be moved together with a single drive.

In order to prevent the article part initially folded upward from being engaged by the disc which is adapted to exert a force on the third article part to be folded thereafter, it is attractive that the first engaging element comprises a part such as a first guide plane which extends above the second disc and the contour of which is adapted to the trailing periphery of the first disc, below the transport element. Thus, the second article part, having been folded to a substantially horizontal orientation, proceeds onto the first guide plane which supports it above the second disc and prevents the second disc from interfering with the second article part.

Similarly, the second engaging element preferably comprises a part such a second guide plane, parallel to the first guide plane, the second guide plane having a contour adapted to the trailing periphery of the second disc, below the transport element.

The device described thus far can fold an article of foldable material in lengthwise direction. There may also be a need for a device which can also make a fold in the transverse direction. A further embodiment of the presently disclosed invention provides that the transport element connects to a cross-folding device. The cross-folding device comprises a supply element for supplying the folded articles from the transport element in a substantially horizontal direction. A guide element, placed under the discharge end of the supply element, is adapted to guide parts of the folded articles released from the supply element. An activating element forces the folded articles into engagement with a discharge element, whereby the discharge element engages folded articles coming from the supply element and which are situated partially on the guide element. A detection element detects the presence of a part of the folded article on the guide element and activates the activating element upon detection.

This embodiment likewise relates to such a method, wherein the longitudinally folded articles are carried from the transport element to a cross-folding device, and that in the cross-folding device the parts of the folded articles released from the discharge end of the supply element are fed to a guide element and that, when reaching a position on the guide element, the articles are carried into engagement with a discharge element by activation of an activating element and are subsequently discharged by the discharge element.

In order to reduce the number of moving parts of such a device as much as possible, it is preferred that the discharge element comprises two conveyor belts, and that the activating element comprises a blow nozzle leading to the point of engagement between the conveyor belts.

In certain situations, there is a need for a second cross fold. A further embodiment of the invention therefore provides more than one such cross-folding device.

### BRIEF DESCRIPTION OF THE SEVERAL VIEWS OF THE DRAWINGS

The present invention will be elucidated hereinbelow with reference to the accompanying drawings, in which:

FIG. 1 shows a schematic perspective view of a device according to the invention;

FIG. 2 is a top view of the device shown in FIG. 1;

FIGS. 3A-3F show cross-sectional views along the lines A-A, B-B, C-C, D-D, E-E and F-F in FIG. 2; and

FIG. 4 shows a detailed longitudinal section view of the device.

### DETAILED DESCRIPTION OF THE INVENTION

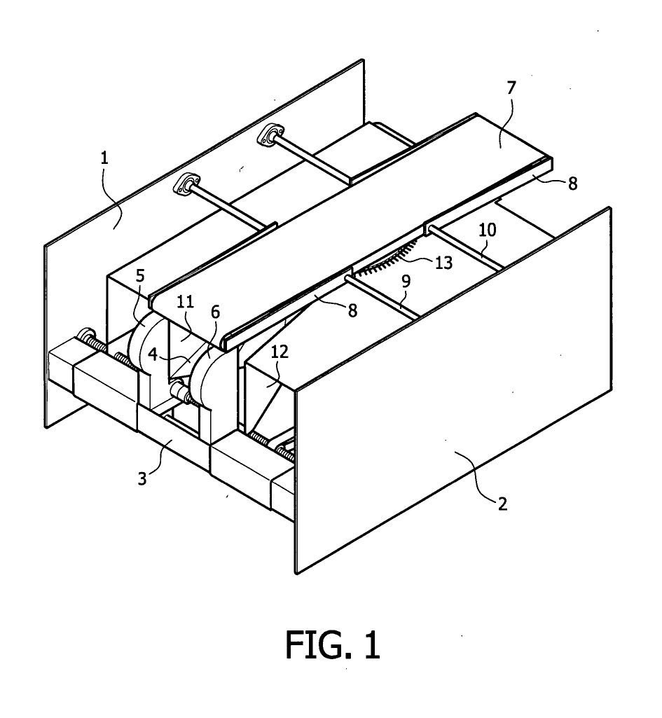

The device shown in FIG. 1 comprises a frame which comprises two side plates 1, 2 which are connected by various connecting elements, including a front connecting element 3 and a rear connecting element (not shown). Disposed in the frame is a horizontally extending folding template 4 over which a part of the article for folding is advanced. This folding template is rounded on the front side of the device to avoid snagging the article. The folding template is formed in part by two slide strips 5, 6 arranged in a sub-frame 8. A conveyor belt 7 mounted in frame 1, 2 is arranged for driving the articles. Strip 5 has a fixed position relative to sub-frame 8. Using threaded spindles 9, 10, the position of strip 6 inside sub-frame 8 and the position of sub-frame 8 itself can be adjusted so that both strips remain centered relative to conveyor belt 7 while enabling the width of the folding template to be adjusted according to the size of the article to be folded.

For the purpose of guiding the articles for folding, two folding guides or elements 11 and 12 are arranged on either side of folding template 4. One of these folding elements is attached to side plate 1, while the other folding element is connected to sub-frame 8 so that its lateral position within the frame 1, 2 can be adjusted together with strip 5. These folding elements 11, 12 extend substantially vertically on the front side of the device but, more toward the interior of the device, they are oriented toward the centre of the belt for the purpose of guiding the articles for folding under conveyor belt 7 and into proper position for engagement by the respective engaging element. The folding elements comprise a first part which is folded three-dimensionally and ensures that the article is pre-folded and that the article only contacts the respective engaging element disc at a location where the disc has a sufficiently large rotational component in the direction of forward movement. The second part of the plate forming the folding element forces the folded part of the article under the template.

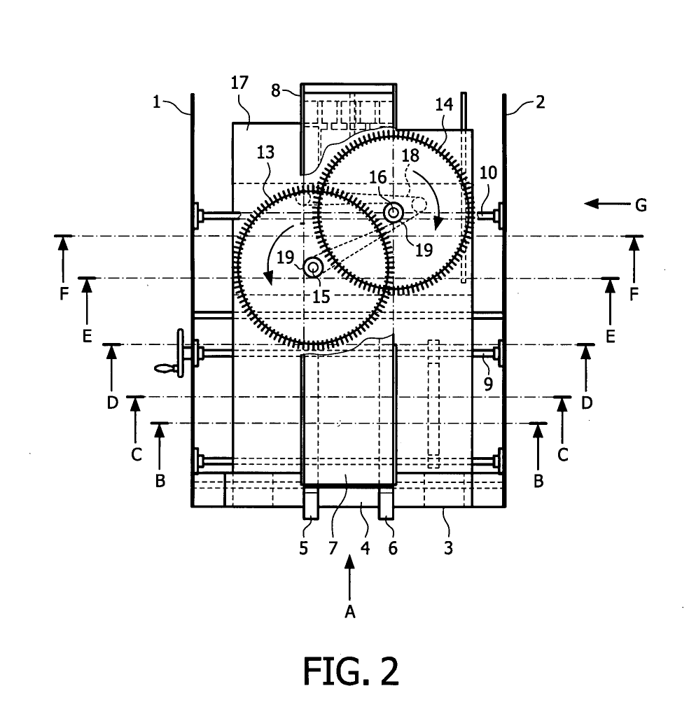

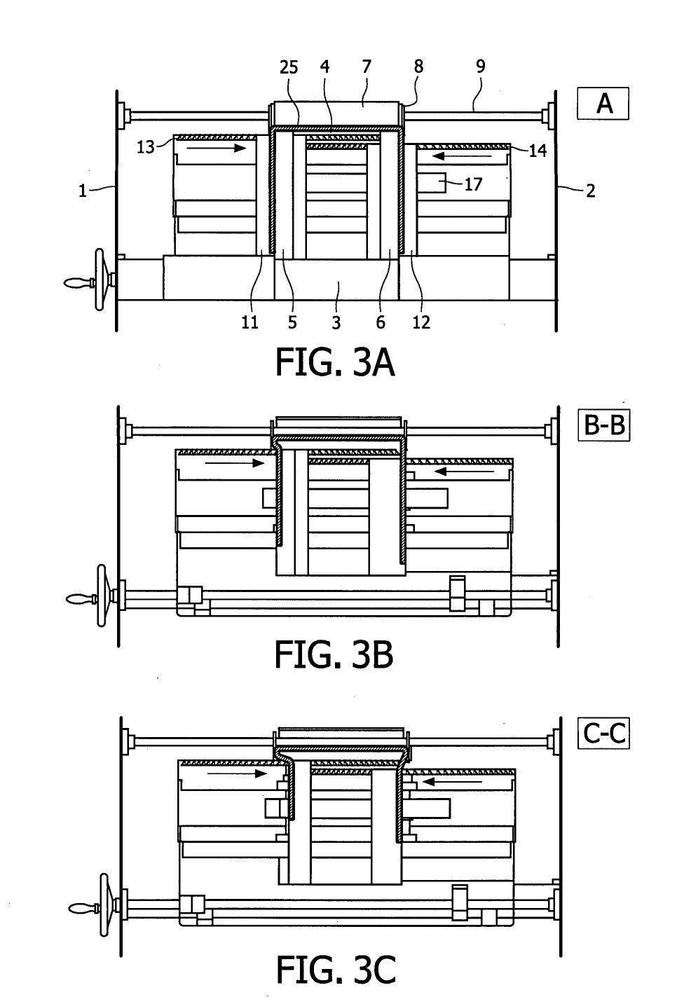

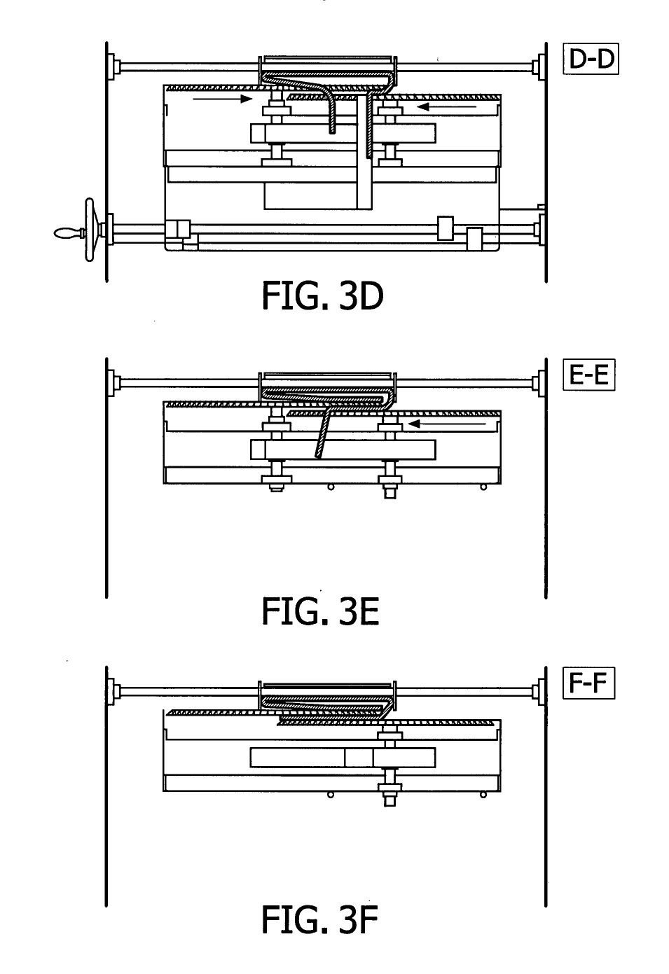

Reference is now made to FIG. 2 and the cross-sections according to FIGS. 3A-F.

The invention provides a substantially horizontally disposed first disc 13 and a likewise substantially horizontally disposed second disc 14. The discs are each mounted on a respective shaft 15, 16. Both shafts are mounted in the sub-frame 8 so that they can be displaced together with slide strip 5 and the folding element through adjustment of the threaded spindles. Discs 13, 14 can be driven together by a motor which is not shown in the drawings and can be driven by means of a toothed belt 18 with pulleys 19, 20 arranged on each of the shafts 15, 16 respectively. The belt and pulley arrangement of FIG. 2 is for illustrative purposes only. In an alternative embodiment, direct drive to each shaft can be employed. The drive may be synchronized with the drive (not shown) associated with the belt 7, either mechanically or via a control loop such as a feedback loop. Alternatively, the drive for the discs may be the same drive as that used for the belt.

The operation of the disclosed device will now be described. After switching on the drive of the discs 13, 14 and of the belt 7, an article 25 to be folded is placed on the slide strips 5, 6. The article is then placed by hand into engagement with conveyor belt 7, wherein conveyor belt 7 engages the article and transports it further in the forward direction of movement against the folding template 4. In order to arrange the folds at the correct location in the article, use is preferably made of stops (not shown in the drawing). A part of the article is carried onto the slide tracks of the folding template whereby part of the article hangs downward on the left-hand side of slide track 4. This is the case when only a single fold is to be made. It is otherwise also possible for another part of article 25 to hang downward on the right-hand side. In this case the device will arrange two folds in article. The latter case is illustrated in FIG. 3A.

The article 25 is moved further by conveyor belt 7, wherein the driving takes place on that part of article 25 being advanced over the folding template 4. The hanging, depending parts of article are only carried along by the part of the article that is being advanced, whereby the depending parts, as a consequence of friction encountered particularly due to folding elements 11, 12, would eventually be pulled askew, resulting in misaligned folds.

The invention however provides for the presence of discs 13, 14 which provide for advancing the depending parts of article 25 to an extent substantially corresponding with that of the conveyor belt. It is noted here that, instead of discs 13, 14, other types of drive element, such as belts, can be employed to impart linear driving force to the depending parts. Discs 13, 14 are preferably provided with natural or synthetic bristles or other flexible engagement members which extend in the radial direction of the disc and which engage the dependent portion of the article 25. The speed of rotation of the discs is chosen such that the engaged articles are driven with a speed component in the direction of movement of conveyor belt 7 which is substantially equal to that of conveyor belt 7. The depending parts of the articles are hereby driven at the same speed as the non-depending parts, thus preventing misalignment of the resulting fold. Discs 13, 14 also have the function of completing the process initiated by folding elements 11, 12 of folding the articles below conveyor belt 7 and folding template 4. The discs are disposed such that they force the depending article parts into a horizontal position. In order to retain this horizontal folded position, the discs 13, 14 connect to guide planes (not illustrated) which carry the parts folded to a horizontal position. The movement is continued by action of the conveyor belt to a position beyond the end of template 4 and first, upper guide plate.

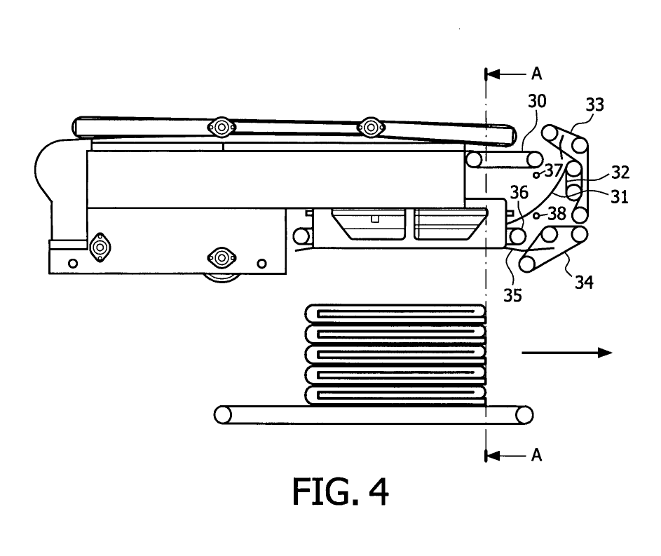

In order to also fold the articles 25 in transverse direction, the folding device described up to this point, which is adapted to make folds in the lengthwise direction, can optionally connect to a cross-folding device. An exemplary cross-folding device is shown in FIG. 4 and comprises a first conveyor belt 30 which receives articles folded in a lengthwise direction from the first folding device. Mounted under the first conveyor belt 30 is a first guide plate 31. Disposed above guide plate 31 and proximate thereto, opposite the first conveyor belt 30, is a pair of second and third conveyor belts 32, 33 which direct articles to a fourth conveyor belt 34. Adjacent the fourth conveyor belt 34 is a second guide plate 35 and a fifth conveyor belt 36. First and second air nozzles 37, 38 are also provided, each selectively connected to a source of compressed air. Each nozzle may comprises a single nozzle or an array of appropriately directed nozzles.

The operation of this cross-folding device is as follows. An article to be provided with a cross fold or folds is supplied onto the first conveyor belt 30. As soon as a part of the article is no longer supported by the first conveyor belt, it drops downward, whereby it comes to lie on the first guide plate 31. This creates a fold in the article at the end of the first conveyor belt 30. By moving the first conveyor belt 30 further, the fold as it were displaces through the article. As soon as the bottom edge of the article reaches a predetermined position on the first guide plate 31, a detector (not illustrated) is activated. The detector may be optical or pressure sensitive, etc. Once detected, the first nozzle 37 is switched on. The airflow generated hereby impinges upon the article substantially at the position of the fold at the end of the first conveyor belt. The airflow subsequently forces the article in the cross-folded state into a position between the second and third conveyor belts 32, 33. The article is thereby provided with a single cross fold.

In certain cases, it may be desirable to arrange a second fold in the article. For this purpose the single-folded article is fed from between the second and third conveyor belts 32, 33 to a fourth conveyor belt 34, in line with which a conveyor belt 36 is placed. As soon as the article has reached a predetermined position on the fifth conveyor belt 36, which is once again detected by a detector (not shown), second nozzle 38 is activated whereby at the position of the nozzle the article is forced downward between fourth and fifth conveyor belts 34, 36 onto the second guide plate 35. A second cross fold is thus formed in the folded article. The twice folded article is discharged on guide plate 35.

Drive means for the first through fifth conveyors 30, 32, 33, 34, 35 is provided by conventionally known drive means such as stepper motors. Control over the various electrically driven elements, including the drives, and selective activation of the compressed air nozzles, is provided by specially programmed general purpose computing elements, or by specially programmed controllers such as digital signal processors.

Although the invention is described through the above-described exemplary embodiments, it will be understood by those of ordinary skill in the art that modifications to, and variations of, the illustrated embodiments may be made without departing from the inventive concepts disclosed herein. Accordingly, the invention should not be viewed as limited, except by the scope and spirit of the appended claims.

What is claimed is:

1. A device for folding a flat article made of foldable material, such as cloth, wherein the articles for folding comprise a first article part and a second article part and wherein the two article parts are to be folded over each other, the device comprising:
a frame;
a transport element disposed in the frame, the width of which being at least as great as that of the first article part;
a first folding element extending from a first side of the transport element to a lateral position below the transport element for forcing the second article part to a lateral position below the transport element; and
a first engaging element disposed on the first side of the transport element partially below the transport element and adapted to engage the second article part below the transport element and to exert a pulling force on the second article part in the direction of movement of the transport element.

2. The device as claimed in claim 1, wherein the first engaging element is a movable engaging element which is drivable with a speed component in the direction of movement of the transport element which is at least as great as the speed of the transport element.

3. The device as claimed in claim 2, wherein the first movable engaging element comprises a first rotatable disc.

4. The device as claimed in claim 3, wherein the first rotatable disc comprises radially extending bristles on the outer circumference thereof.

5. The device as claimed in claim 3, wherein the first rotatable disc is disposed substantially horizontally and wherein the tangent of the first disc in the direction of movement of the transport element corresponds with the vertical projection of the edge on a second side of the transport element.

6. The device as claimed in claim 1, wherein the device further comprises:
a second folding element extending from a second side of the transport element for forcing the third article part to a lateral position below the transport element; and
a second engaging element disposed on the second side of the transport element partially below the transport element and adapted to engage the third article part below the transport element and to exert a pulling force on the third article part in the direction of movement of the transport element,
wherein the device is adapted to fold the first and the third article parts connected to the first article part, wherein the width of the transport element corresponds to the width of the first article part.

7. The device as claimed in claim 6, wherein the second engaging element is a movable engaging element which is drivable with a speed component in the direction of movement of the transport element which is at least as great as the speed of the transport element.

8. The device as claimed in claim 7, wherein the second movable engaging element comprises a second rotatable disc.

9. The device as claimed in claim 8, wherein the second rotatable disc comprises radially extending bristles on the outer circumference thereof.

10. The device as claimed in claim 8, wherein the second rotatable disc is disposed substantially horizontally and wherein the tangent of the second disc in the direction of movement of the transport element corresponds with the vertical projection of the edge on the first side of the transport element.

11. The device as claimed in claim 8, wherein the diameter of each of the first and second discs is greater than the width of the transport element, and wherein the second rotatable disc is disposed behind the first rotatable disc in the direction of movement of the transport element.

12. The device as claimed in claim 1, wherein the transport element comprises a folding template and a conveyor belt extending thereabove and wherein the conveyor belt is adapted to move the first article part for folding over the folding template.

13. The device as claimed in claim 1, wherein the folding template comprises two slide strips, wherein the distance between the two strips is adjustable.

14. The device as claimed in claim 13, further comprising at least one spindle extending substantially transversely of the direction of movement of the transport element and adapted to laterally displace one of the slide strips on the second side of the folding template.

15. The device as claimed in claim 14, wherein the first folding element comprises a guide plane which extends above the first disc and the contour of which is adapted to conform to the periphery of the first disc.

16. The device as claimed in claim 1, further comprising a cross-folding device comprising:
a supply conveyor belt for receiving a folded article from the transport element in a substantially horizontal direction;
a first guide element placed under a discharge end of the supply conveyor belt, wherein the first guide element is adapted to guide a part of the folded article released from the supply conveyor belt;
a discharge element for discharging by means of engagement folded articles coming from the supply conveyor belt and situated partially on the first guide element;
an activating element for forcing the folded articles into engagement with the discharge element; and
a detection element for detecting the presence of a part of the folded article on the guide element and for activating the activating element when this presence is detected.

17. The device as claimed in claim 16, wherein the discharge element comprises first and second discharge conveyor belts, and wherein the activating element comprises at least one compressed air nozzle directed at the point of engagement between the first and second discharge conveyor belts.

18. The device as claimed in claim 16, further comprising plural cross-folding devices.

19. A method for folding an article made of foldable material, such as cloth, comprising the steps of:
placing the article for folding partially into engagement with a transport element;
linearly transporting the article using the transport element, wherein a part of the article not in engagement with the transport element is forced by at least a first folding element extending from a side of the transport element to a position below the transport element; and
engaging a part of the article not in engagement with the transport element by at least one engaging element, wherein the engaging element exerts a pulling force, in the direction of movement of the transport element, on the part of the article not in engagement with the transport element.

20. The method as claimed in claim 19, wherein the engaging element is driven at a speed in the direction of movement of the transport element which is at least as great as that of the transport element and forces the part of the article not in engagement with the transport element into a substantially horizontal position below the part of the article in engagement with the transport element to form a folded article.

21. The method as claimed in claim 19, further comprising the steps of advancing the article for folding from the transport element to a cross-folding device, whereby the folded article is released from a discharge end of a supply element, partially fed onto a guide element, carried into engagement with a discharge element by activating an air folding element when at a predetermined position on the guide element, and subsequently discharged by the discharge element.
